(19) United States
(12) Patent Application Publication
(10) Pub. No.: US 2005/0218804 A1
(43) Pub. Date: Oct. 6, 2005

(54) Halogen incandescent lamp for mains voltage

(75) Inventor: Adrianus Maria Goijaerts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/517,923

(22) PCT Filed: May 27, 2003
(86) PCT No.: PCT/IB03/02384

§ 371 Date: Dec. 14, 2004

(51) Int. Cl. H01J 61/24

(52) U.S. Cl. 313/547

(57) ABSTRACT

The mains voltage halogen incandescent lamp has a coiled-coil filament (10) having single-coiled legs (16). In order to obviate sag of the filament barrel (11) when positioned horizontally, the turns (17) of the legs (16) have a pitch (p17) which is larger than the pitch (p12) of the primary turns (12) of the barrel (11).

The invention relates to a halogen incandescent lamp for mains voltage, comprising:
a light-transmitting lamp vessel closed in a gastight manner and having a wall;
an incandescent body substantially made of tungsten arranged in the lamp vessel and provided with:
a coiled-coil barrel with primary turns having a pitch and with secondary turns, and
single-coiled legs having turns with a pitch;
current conductors embedded in the wall of the lamp vessel and issuing therefrom to the exterior, which current conductors are each connected to a respective leg; and
a gas filling comprising halogen in the lamp vessel.

An embodiment of such a halogen incandescent lamp is known from U.S. Pat. No. 4,683,397.

Halogen incandescent lamps have incandescent bodies made of thinner wires than GLS lamps because they have a higher operating temperature. Mains voltage lamps have incandescent bodies of thinner wires than lamps for low voltage, i.e. a voltage of less than 80 V, so as to achieve a sufficiently high electrical resistance. In proportion as the consumed power of the lamps is smaller, the wire thickness of the incandescent body will also be smaller. Mains voltage halogen lamps of comparatively low power, for example below 300 W, in particular below 100 W, for example 60 W or less, accordingly have incandescent bodies made of very thin wires, for example a few tens of micrometers.

Mains voltage halogen lamps of comparatively low power have incandescent bodies of helically coiled wire, and the primary winding having primary turns is in its turn helically coiled so as to form secondary turns. A wire of, for example, hundreds of mm length is formed into a compact incandescent body of, for example, a few tens of mm length in such a coiled-coil incandescent body. This compactness gives the lamp a comparatively high luminous efficacy because losses caused by heat radiation are limited.

A coiled-coil incandescent body is obtained in that a tungsten wire is coiled on a primary mandrel, for example of molybdenum, so as to obtain the primary turns, whereupon the enveloped primary mandrel is coiled around a thicker, secondary mandrel so as to obtain the secondary turns. A portion of the primary mandrel with primary turns is left uncoiled during this at either side of the secondary turns. These portions, or rather the primary turns around these portions, will form the legs of the incandescent body in the finished lamp. The incandescent body is created from the product formed by coiling in that the primary and the secondary mandrel are dissolved.

As the wire of the incandescent body becomes thinner, the incandescent body will become slacker and will sag under the influence of gravity when suspended horizontally, in the manner of a horizontally suspended chain. This sagging is a disadvantage because the incandescent body as a result loses its defined position in the lamp vessel. Sag may be the cause of the incandescent body touching the lamp vessel, so that it loses heat and accordingly gives less light. Sag may have the result that secondary turns come into contact with one another, whereby portions of the incandescent body are short-circuited and the incandescent body is overloaded, which leads to a premature end of lamp life. Sag may be unpleasant if the lamp is used in an optical system because the incandescent body will then occupy a position other than the defined one, for example outside the focus of a reflector that may be connected to the lamp, or outside the centerline of a heat filter that may be connected to the lamp.

The cited U.S. Pat. No. 4,683,397 has for its object to give the incandescent lamp a greater strength through a certain choice of diameter for the primary and the secondary turns. In addition, the primary coiling mandrel is for this purpose present in the turns of the legs of the incandescent body (4:53-60). This is a major disadvantage because the retention of the primary coiling mandrel in the legs requires complicated additional manufacturing steps and is accordingly expensive. Before being removed from the coiled incandescent body by etching, the primary coiling mandrel must be coated at the areas of the legs with a compound that remains intact in the etching liquid and which prevents dissolving of the primary coiling mandrel at the areas of the legs. After the coiling mandrel has been removed by etching at the area of the barrel of the incandescent body, the protective compound is to be removed, and the incandescent body is to be cleaned.

It is an object of the invention to provide a halogen incandescent lamp for mains voltage of the kind described in the opening paragraph which is of a simple construction, while sagging of the incandescent body is counteracted.

According to the invention, this object is achieved in that the legs are substantially composed of turns whose pitch is greater than the pitch of the primary turns.

It was found that the legs of the incandescent body have a greater rigidity in proportion as the pitch of the primary turns is greater. They are better capable of supporting the barrel as a result. The construction of the incandescent body is simple because the primary mandrel need not be retained at the areas of the legs.

The legs of the incandescent body may be coiled with a greater pitch around the primary mandrel than the primary turns of the incandescent body, in which case they will have the same diameter as the primary turns. It is favorable, however, if the turns of the legs and the primary turns of the barrel have respective diameters, such that the diameter of the turns of the legs is smaller than the diameter of the primary turns of the barrel. The greater pitch of the turns of the legs may then be obtained in that the legs are stretched. The primary turns of the incandescent body and of the legs may then be manufactured with a constant pitch, which is simple to realize. The result of the stretching of the legs for making the pitch of the turns greater than that of the primary turns of the barrel of the incandescent body is that the diameter of the turns of the legs will be smaller than the diameter of the primary turns of the barrel.

The legs have their greatest rigidity when they are completely stretched out, i.e. when the pitch is infinitely great. It is of little relevance, however, to straighten the legs out fully. The stiffness is only slightly greater then than if the pitch/diameter ratio of the legs is approximately 10, which can be readily realized. If a coiled wire is to be fully straightened, it is to be plastically deformed to a comparatively high degree under a comparatively high tensile load, which is more difficult to realize and involves a risk of fracture.

The current conductors may enter the wall of the lamp vessel next to one another. It is alternatively possible for the current conductors to be positioned opposite to one another in the wall. In the former case, one of the current conductors may extend alongside the incandescent body inside the lamp vessel, and the incandescent body may be in a linear position. Alternatively, the incandescent body may be folded in the former case, for example V-shaped or U-shaped, while being held in a fixed position by means of a support between its legs. The support may be a metal, for example molybdenum wire which is anchored in the wall of the lamp vessel. In the latter case, the incandescent body may be supported between its legs, for example in the case of a lamp for comparatively high voltage, for example 230 V, or a lamp for comparatively low voltage, for example 110 V, and accordingly having a comparatively short incandescent body. It is favorable if the incandescent body has a single-coiled portion at the area of a support. The incandescent body will then dissipate less energy at the area of the support. It is favorable for counteracting sag if the turns have a pitch greater than the pitch of the primary turns of the barrel of the incandescent body in the respective location.

The lamp vessel may be made of glass, for example glass having an SiO₂ content of at least 95% by weight such as, for example, Vycor or quartz glass, or of hard glass such as, for example, borosilicate glass. Alternatively, the lamp vessel may be made of a ceramic material such as, for example, aluminum oxide. If the lamp vessel is made of quartz glass, for example, an indentation of the lamp vessel onto the incandescent body may constitute a support for the incandescent body.

The lamp vessel may be cylindrical, or alternatively, for example, ellipsoidal, the incandescent body being arranged on the major axis of the ellipsoid. The lamp vessel may be provided with an IR-reflecting coating, for example made of alternating layers of tantalum pentoxide and silicon oxide.

The lamp vessel may be accommodated in and fixedly connected to a reflector, for example a reflector curved in accordance with a parabola branch. The reflector may be closed off by a transparent plate. Another possibility is that the lamp vessel is accommodated in an outer envelope, for example a glass, for example hard-glass, tubular envelope which is of bulbous shape laterally of the incandescent body. The outer envelope of the lamp vessel may be provided with a lamp base, for example an Edison or bayonet lamp base.

Embodiments of the halogen incandescent lamp according to the invention are shown in the drawing, in which:

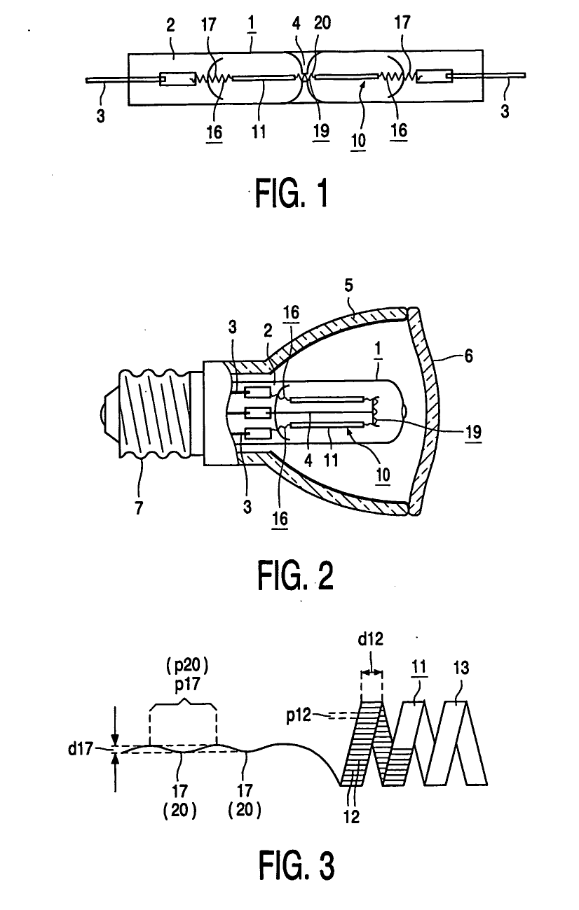

FIG. 1 shows a first embodiment in side elevation;

FIG. 2 shows a second embodiment in side elevation, partly broken away; and

FIG. 3 diagrammatically shows a detail of the incandescent body of FIGS. 1 and 2.

In FIG. 1, the halogen incandescent lamp for mains voltage has a translucent lamp vessel 1 which is closed in a gastight manner and which has a wall 2, made of quartz glass in the Figure. An incandescent body 10 substantially made of tungsten is positioned in the lamp vessel 1. It is provided with a coiled-coil barrel 11 having primary turns 12 with a pitch p12, see also FIG. 3, and with secondary turns 13, and single-coiled legs 16 having turns 17 having a pitch p17. Current conductors 3 embedded in the wall 2 of the lamp vessel 1, opposite to one another in the Figure, issue from said wall to the exterior. The current conductors 3 are connected to respective legs 16. The current conductors 3 can be connected outside the lamp vessel, for example to R7s contacts so as to form a double-ended lamp. A gas filling comprising halogen is present in the lamp vessel 1. The gas filling comprises an inert gas, for example xenon and nitrogen, and hydrogen bromide or methylene bromide.

The legs 16 substantially comprise turns 17, see also FIG. 3, whose pitch p17 is greater than the pitch p12 of the primary turns 12.

The turns 17 of the legs 16 and the primary turns 12 of the barrel 11 have respective diameters d17 and d12, such that the diameter d17 of the turns 17 of the legs 16 is smaller than the diameter d12 of the primary turns 12 of the barrel 11.

The incandescent body 10 has a single-coiled portion 19 between its legs 16, as an intermediate portion of the barrel 11, with turns 20 having a pitch p20 greater than the pitch p12 of the primary turns. The lamp vessel 1 is indented in this location so as to form a support 4 for the incandescent body 10.

In FIG. 2, components corresponding to components of FIG. 1 have been given the same reference numerals. The current conductors 3 are arranged next to one another in the lamp vessel 1. The incandescent body 10 is U-shaped. The single-coiled portion 19 is kept in position by a molybdenum support 4 which is embedded in the wall 2 of the lamp vessel 1. The lamp vessel 1 is accommodated in a reflector 5 which is closed off by a transparent plate 6 and which supports an Edison lamp base 7.

A tungsten wire of 30.9 μm diameter was used for making an incandescent body for a halogen incandescent lamp of 60 W/230 V. The wire was coiled with a pitch of 51 μm around a mandrel of 59.5 μm. The enveloped mandrel was coiled around a secondary mandrel of 259.8 μm diameter. Portions of the primary mandrel from which legs are to be created were kept substantially linear during this.

The mandrels were removed by etching. An incandescent body was thus obtained with a coiled-coil barrel and with single-coiled legs. The primary turns of the barrel and the turns of the legs had a diameter of 121.5 μm. The pitch/diameter ratio of the wire was 1.65. The pitch of the turns of the legs was increased while at the same time their diameter was reduced in that the legs were stretched until the pitch/diameter ratio of the wire of the leg turns was approximately 10. The incandescent body was mounted in a tubular lamp vessel so as to obtain a lamp according to the invention and was compared with an incandescent body coiled from identical wire in an identical manner and mounted in a tubular lamp vessel without prior stretching of the legs. It was ascertained that the incandescent body of the lamp according to the invention showed substantially less sag.

1. A halogen incandescent lamp for mains voltage, comprising:
a light-transmitting lamp vessel closed in a gastight manner and having a wall;
an incandescent body substantially made of tungsten arranged in the lamp vessel and provided with:
a coiled-coil barrel with primary turns having a pitch and with secondary turns, and
single-coiled legs having turns with a pitch;
current conductors embedded in the wall of the lamp vessel and issuing therefrom to the exterior, which current conductors are each connected to a respective leg; and
a gas filling comprising halogen in the lamp vessel, characterized in that the legs are substantially composed of turns whose pitch is greater than the pitch of the primary turns.

2. A halogen incandescent lamp as claimed in claim 1, characterized in that the turns of the legs and the primary turns of the barrel have respective diameters, and the diameter of the turns of the legs is smaller than the diameter of the primary turns of the barrel.

3. A halogen incandescent lamp as claimed in claim 1, characterized in that the incandescent body has a single-coiled portion between its legs with turns having a pitch greater than the pitch of the primary turns.

4. A halogen incandescent lamp as claimed in claim 1, characterized in that the lamp vessel is accommodated in a reflector.
